(19) United States
(12) Patent Application Publication
(10) Pub. No.: US 2024/0327289 A1
(43) Pub. Date: Oct. 3, 2024

(54) PROCESS AND APPARATUS FOR PRODUCING A LOW CARBON PRODUCING GEOPOLYMER

(71) Applicant: James Khreibani, Miami Beach, FL (US)

(72) Inventor: James Khreibani, Miami Beach, FL (US)

(21) Appl. No.: 18/588,395

(22) Filed: Feb. 27, 2024

Related U.S. Application Data
(60) Provisional application No. 63/448,579, filed on Feb. 27, 2023.

(51) Int. Cl. C04B 28/26; C04B 22/06; C04B 40/00

(52) U.S. Cl. CPC C04B 28/26; C04B 22/062; C04B 40/0082

(57) ABSTRACT

The invention presents an advanced method for geopolymer cementitious material production, introducing processes to enhance efficiency, sustainability, and versatility. The method integrates a geopolymer cement mixing stage that blends diverse raw materials such as fly ash and waste with facility-produced sodium hydroxide produced via electrolysis methods while also producing hydrogen from the electrolyzer that may be used for facility heat. A sodium silicate producing stage, using the wet method or alternative processes, is included. The geopolymer cement mixing stage ensures homogenous combination of sodium hydroxide, sodium silicate, fly ash and other components. A geothermal heat pump may be employed for low-temperature heating. This method optimizes raw material use, addresses environmental concerns, and signifies a substantial advancement in geopolymer production.

### CROSS-REFERENCE TO RELATED APPLICATIONS

This patent application claims the priority date benefit of provisional patent application Ser. No. 63/448,579, filed 27 Feb. 2023 by the present inventor, which is incorporated herein in its entirety by reference.

### TECHNICAL FIELD

The present invention relates to processes and apparatus for producing geopolymer-based shaped and unshaped articles. Without limitation, the present invention relates to processes and apparatus for producing shaped or unshaped articles using geopolymer pozzolanic type materials and pozzolanic type waste materials.

### BACKGROUND ART

Combustion of fossil fuels for the production of electricity (e.g. in power stations) and heat (e.g. in smelters) results. in the production of a number of pollutants, as discussed, for example, in U.S. Ser. No. 11/479,512B2. More specifically, one example is in coal-fired power stations, the combustion of coal produces a variety of waste materials, including fly ash (the fine ash particles which become entrained in the flue gas) and bottom ash (the heavier ash which falls to the bottom of the boiler). In order to comply with environmental requirements, these ashes cannot be discharged into the environment but must be collected for subsequent disposal or recycling. One useful method of recycling these waste products is to use them as a replacement or partial replacement component for Portland Cement in concrete production. Due to the relatively high cost of producing the Portland Cement, incorporating fly ash into a cementitious material can provide substantial cost and environmental savings by creating a useful geopolymer, a term used herein to describe such a composition of ash and cement materials (also called pozzolanic, alkali-activated, roman cement, green cement, or other similar names describing a product that is not 100% Portland Cement). The challenges faced for coal fly ash also present a challenge for other recycled or waste material which may be made of bottom ash, non saleable fly ash, paper, glass, rice hulls, crushed concrete, polymers, petrochemicals, sawdust, wood chips, municipal solid waste (MSW) incinerator ash, medium density fiber board (MDF) dust, soil, other materials having similar properties, or combinations thereof.

There is a need in the art to further reduce the cost and increase the environmental benefit of geopolymers. The geopolymer process described below is an improvement of the prior art as: (i) it can be implemented in any desired geographical location, therefore making it more flexible, and (ii) it provides for feedstock supply chain security and flexibility as the production of chemical components of the geopolymer are manufactured as part of the invention, from easily available commodity ingredients and in close proximity to the geopolymer cement plant presenting an additional advantage in cementitious material production.

### SUMMARY OF THE INVENTION

In one embodiment of the invention, a chemical plant comprising an electrolyzer is located in close proximity to the geopolymer production facility that may or may not use the heat from the geothermal heat pump to increase the temperature of an electrolyzer and the electrolyzer internal fluid. The electrolyzer may be configured to produce a range of alkaline chemicals including sodium hydroxide and potassium hydroxide along with additional hydrogen and chlorine compounds. The electrolyzer may be configured to accept a range of inputs including electricity, water and sodium/sodium chloride. The term sodium hydroxide is used to describe the chemical compound produced by the electrolyzer but in this disclosure can also be used to describe other similar alkaline chemicals produced by electrolysis such as potassium hydroxide for example and without limitation and all alkaline chemicals should be considered within the scope of this invention.

The chemical plant located in close proximity to the geopolymer production facility may use a proportion of the sodium hydroxide in the cement plant to produce geopolymer, wherein the sodium hydroxide may also be sold to market as a stand-alone product.

The chemical plant may then use a portion or all of the sodium hydroxide to produce sodium silicate using a variety of technologies. For example, one method of producing sodium silicate involves mixing sodium hydroxide with sand while heating and stirring, often under pressure.

The chemical plant may then use a portion of the sodium hydroxide to produce sodium silicate. For example, one method of producing sodium silicate may involve mixing sodium hydroxide with alternative feedstock, for example, pot ash. In another embodiment of the same invention, an alternative method of producing sodium silicate is used.

The chemical plant that is used to manufacture the sodium silicate may also be located at a separate location to the chemical plant that is used to manufacture sodium hydroxide. However, the sodium silicate chemical plant shall be located in close proximity to the separate chemical plant that is used to manufacture sodium hydroxide, the geopolymer production facility, and/or both facilities. The advantage of a close geological location between facilities that utilize and require similar materials is that transportation costs are reduced, and each facility can utilize and share common services such as geothermal heat and power.

In another embodiment of the same invention, all facilities or a portion of the facilities mentioned in this invention are co-located at a single geographical location, thereby reducing infrastructure costs of transporting products between facilities.

A combustion stage may be part of the process and may receive hydrogen from the electrolyzer which may be the same or different electrolyzer used to produce the sodium hydroxide and combust the hydrogen to produce power and heat by utilizing a gas turbine, fuel cell, and/or burner. Power generated by the combustion stage may be supplied back into the facilities overall power grid where it is used to operate machinery and/or site services. When produced in close proximity to the combustion plant, the waste heat from combustion may be utilized to support heat demands of the sodium silicate reaction or another process.

Any heat or power that is not consumed by the facilities production operations may be consumed by an energy storage and release system, for example a battery, sand battery, or sold back into the grid. A sand battery uses the thermal storage and heat transfer properties of sand and sand-like materials to store heat by heating the sand using excess heat energy where it is stored in insulated containers until the heat is needed where by the heat is released from the sand by transferring stored heat to a cooler working fluid. Storing the additional heat and power when surplus is generated, followed by a release at the time of need, allows the lowering of carbon dioxide produced from the generation of heat and power, and a more even production thereof.

The combustion stage of the process may be configured to operate on multiple fuels should hydrogen supply be insufficient to provide the required heat and power demands. Examples of additional suitable fuels include methanol, methane, natural gas, synthetic natural gas, fuel oil, coal, biomass, hydrogen produced outside of this disclosure or other combustible product which may be blended with hydrogen or used by itself. Power and heat may also be sourced from the electrical grid or surrounding facilities for example solar or wind.

The chlorine produced by the electrolyzer may be captured and sold into the market or used for other purposes, for example producing hydrochloric acid, bleach or used in desalination plants and therefore generating additional revenue streams.

The sodium silicate produced within the chemical plant may then be consumed by the geopolymer cement mixing stage. Any remaining sodium silicate may be stored or sold to the market.

The geopolymer cement mixing process may also consume additional water not already introduced into the process with sodium hydroxide, sodium silicate and other alkaline chemicals. The geopolymer cement mixing process may also consume fly-ash, iron oxide, tailings, sand, aggregates, gravel waste products and other compounds. Some or all of these may be produced on the same facility or at close geographical location as the combustion, cement and chemical plant stages with the present invention.

The geopolymer cement plant may have a mixing stage within the process that combines all needed materials needed in their respective measured quantities to meet the specified ratios required to produce the desired properties of the final product. In one embodiment and by way of example, the cement mixing stage may use mechanical rotation to mix the materials.

The geopolymer cementitious material may then be sold directly to the market and used as a replacement or semi-replacement for traditional concrete, for example Ordinary Portland Cement. It can also be poured and/or pressed/extruded into shaped products, for example bricks, precast concrete structures, modular homes, fire resistant concrete panels, railway sleepers, or other cementitious product. In another embodiment of the same invention the alkaline components including for example and without limitation Sodium hydroxide, potassium hydroxide, sodium silicate and other are mixed into a separate binder and not mixed with fly-ash, aggregates and other materials and are sent separately to the market. Once received the market customer mixes these compounds separately to produce the final geopolymer cementitious material.

In one embodiment of the same invention describes a process where a heat pump is used, which may be geothermal or ground source in nature and may comprise multiple design configurations and working fluids to provide a heat source required to produce an integrated geopolymer cement and other useful chemical products. The general principles of the heat pump are well known to one skilled in the art. Configuring the heat pump to use the constant temperature of the ground to drive the process described herein has further advantages, which are unique to this process. As an alternative to a traditional design, the heat pump may also be configured to use an external body of water, the outside air's ambient temperature, or another natural feature. One or multiple working fluids, also known as refrigerants, may be used. The selection of a working fluid should be made based on site-specific conditions and the required heat and thermal output needs.

One useful working fluid is carbon dioxide (CO₂) which, due to its low freezing point, low critical point, and good thermal properties, allows for achieving heating temperatures that can exceed 100° C. The heat benefits are further enhanced when CO₂ is operated through trans-critical conditions allowing its use across many geographical locations. For example, and without limitation, a standard air source heat pump (ASHPs) using HFC refrigerants can typically deliver water at a maximum of 65° C. at −4° C. ambient conditions with a coefficient of performance (CoP) of around 2.0. at the same time, a CO₂ ASHP can deliver hot water at 80° C. in −10° C. ambient conditions with a CoP of 2.8. Therefore, when the heat pump uses CO₂ as a working fluid, higher working temperatures at lower ambient temperatures may be achieved when compared to conventional heat pumps. The benefits of CO₂ can also be utilized using Ammonia, R113, R11, methanol, ethanol, water, or other fluids used as refrigerants, all of which are considered to be within the scope of this invention.

The geopolymer cement plant may use the heat from the heat pump to dry dewatered pond ash from approximately 30% moisture content by weight to the required levels of moisture to form the geopolymer, which are between 0% and 20% moisture content. The ability to accept moist fly ash often harvested by dredging pond ash allows hazardous waste to be recycled for an environmental benefit without having to dry the feedstock and then reintroduce water to form the geopolymer.

in addition to using the heat to dry the ash, the geopolymer cement plant may also use the heat produced by the heat pump to increase the temperature of the dry or wet fly ash before it is combined with other constituent parts of the geopolymer cement mixture. Such other constituents may include, for example, and without limitation, Sodium Hydroxide, Sodium Silicate, Sand, Iron Oxide, Sand, Waste Plastic, or other waste materials. The advantage of increasing the heat of the geopolymer cementitious feed products helps to accelerate the curing process.

The geopolymer cement plant may also use the heat from the geothermal heat pump to increase the temperature of the water before entering the geopolymer cement mixture. The advantage of increasing the heat of the geopolymer cementitious feed products also helps accelerate the curing process.

The geopolymer cement plant may also use the heat from the geothermal heat pump to increase the temperature of other components before entering the geopolymer cement mixture. The advantage of doing so is that the curing process is again accelerated, and the amount of external heat needed to initiate curing stage is reduced.

The geopolymer cement plant may also use the heat from the heat pump to increase the temperature of the geopolymer cementitious material exiting the geopolymer cement mixture process to initiate and/or to maintain the pozzolanic-like geothermal reaction required for curing.

In another embodiment of the invention, the heat pump drying system utilizes a recirculation loop where a portion of the drying air is recirculated back through a component in the heat pump process, for example the gas cooler. The advantage of incorporating a recirculation loop is that heat that would have ordinarily been emitted to the atmosphere is reused. Reusing the heat reduces the size of the heat pump drying system and reduces the electricity demand to run the compressor, thereby further reducing the CO₂ emissions per ton of the geopolymer material produced.

In another embodiment of the invention, the fluidized bed drying system is used to dry the fly ash using methods known in the art. In a further embodiment, the fluidized bed drying system may be used to mix dry or wet feedstock components of the geopolymer cementitious mixture, for example, iron oxide, sand, or aggregate, providing a more complete mixing process.

In yet another embodiment, a substance of relatively low carbon for example metakaolin, silica fume, fly ash, slag, VCAS (vitrified calcium alumino-silicate) and kaolinite, or produced as a waste product, may be used as a complete or partial replacement for fly ash to produce a geopolymer. Sodium Silicate may be replaced by potassium silicate or another silicate-based product in the production of a geopolymer cementitious mixture.

The geopolymer cementitious material process may be designed in various configurations and arrangements and incorporate more or less components within the spirit of this invention.

The machinery used to produce the geopolymer cementitious material may be manufactured in various configurations, materials and arrangements and incorporate more or less components within the spirit of this invention.

The feedstock used to produce the geopolymer cementitious material may be of various originals and material that, when comprised together, produce a geopolymer product with the same intent of having a usable alkali chemical plant in the same geographical location and interconnected by site and/or services is used.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows a flow diagram of the process according to the invention.

FIG. 2 shows an alternative flow diagram of the process according to the invention including a heat pump.

FIG. 3 shows an alternative flow diagram of the process according to the invention where binder material is supplied from the plant before geopolymer mixing.

### DETAILED DESCRIPTION OF THE INVENTION

To better understand the invention a description of the inventions geopolymer production process will be described in more detail for one of the many embodiment of this invention.

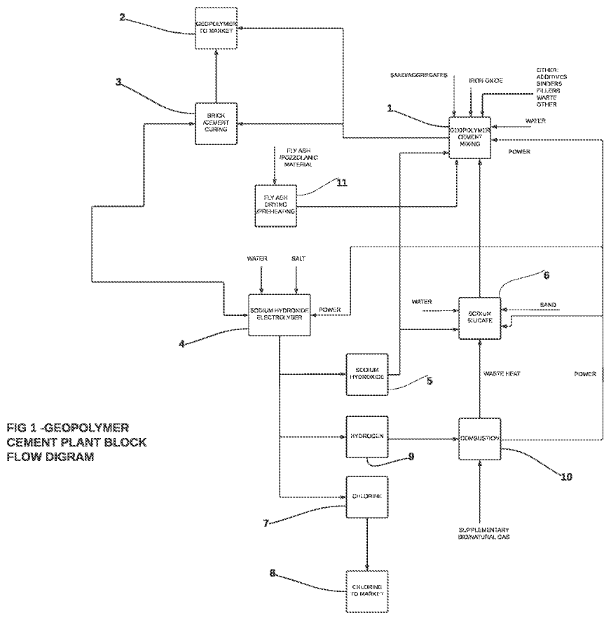

Referring to FIG. 1 shows the raw material and feedstock needed to produce the geopolymer cementitious material arrive at the geopolymer production facility where the geopolymer cementitious material will be produced. The raw materials may include a combination of a number of materials that may include water, fly ash, metakaolin, silica fume, fly ash, slag, VCAS (vitrified calcium alumino-silicate), sand, stone, bio-char, aggregate, waste plastic, pyrolysis oil, kaolinite, rock, salt, iron oxide, natural gas, biogas, power, silica, or other useful material.

A number of process stages that provide the geopolymer cementitious material are located in close proximity and include the geopolymer cement mixing stage, the chemical plant stage, the combustion stage and heat pump stage.

The geopolymer cement mixing (1) stage generally involves the same equipment that is found in a standard cement mixing stage for Ordinary Portland Cement or other traditional cement production plant and mixes all the materials needed to produce the geopolymer including dry, wet and moist feedstock material previously discussed in this invention and includes all or in part the following compounds water, sodium silicate, sodium hydroxide, potassium hydroxide, fly ash, sand, waste sand from reactors, stone, aggregates, iron oxide and other materials of useful value. When the correct consistency is achieved the geopolymer cementitious material leaves the geopolymer cement mixing (1) stage and is either routed direct to the customer as geopolymer to market (2) for pouring or to be cured as brick/cement curing (3) The geopolymer cementitious material may be transferred from the geopolymer production facility to the customer in the geopolymer to market (2) stage using various means including truck, train, ship or other mode of transport. The brick/cement curing (3) stage receives geopolymer cementitious material from the geopolymer cement mixing. stage, where it is poured or placed into a mold, extrusion machine or other forming device to produce geopolymer bricks, pavers, beams, tiles, panels, walls sleepers, curb stones or other shaped product. The shaped products may be formed using a range of pressures or vacuums at levels needed to form the required shaped product before entering the geopolymer to market (2) stage.

The Chemical Plant produces some or all of the geopolymer cementitious materials chemical, feedstocks including sodium hydroxide, sodium silicate, hydrogen and other. There are various technologies that produce sodium hydroxide, and all covered within the scope of this invention. One method requires the use of electrolysis using an sodium hydroxide electrolyzer (4) that produces both sodium hydroxide (5), hydrogen (9) and chlorine (7) as co-products. Generally, sodium hydroxide electrolyzer (4) contains an anode and cathode enclosed within a pressure retaining vessel. The salt and water feedstock of acceptable quality are introduced into the sodium hydroxide electrolyzer (4) vessel and form a brine solution. The sodium hydroxide electrolyzer (4) passes an electrical current through the brine solution (sodium chloride and water) between the anode (positive charge) and cathode (negative charged) where Chlorine gas is generated at the anode and hydrogen and sodium hydroxide are produced at the cathode. The typical chemical reaction, used without limitation can be described by the following equation:

2NaCl(aq) (or KCL)+2H₂O₍ₗ₎→H_{2(g)}+Cl_{2(g)}+2NaOH_{(aq)} (or KOH)

There are different types of electrolyzers (electrolytic cells) used to produce sodium hydroxide from brine, for example, Castner-Kellner Cell (Mercury Process), Nelson Diaphragm Cell, Membrane Cell, and others, all of which are contemplated to be within the scope of this invention. The sodium hydroxide (5) solution is routed to both the geopolymer cement mixing (1) stage process and sodium silicate (6) stage process in the required proportions needed by each process. The Chlorine (7) is further processed into useful substances (not shown) or sold directly to the market (8). The hydrogen (9) is routed to the combustion stage (10). Reject brine solution can be recirculated and reused or filtered and sent to the geopolymer cement mixing stage to further increase the alkalinity of the process water (not shown).

There are various technologies that produce sodium silicate (6) and all are covered within the scope of this invention. One method called the wet method, produces liquid sodium silicate (6), also known as water glass by treating a mixture of silica (usually as quartz sand), sodium hydroxide (caustic soda), and water, with hot steam in a reactor. An example of the overall reaction is:

2NaOH+SiO₂→(Na₂O)_{x′}SiO₂+xH₂O

An alternative process to produce sodium silicate and also within the scope of this invention may use the reaction from sodium hydroxide (NaOH), ferrosilicon, and water (H₂O) within a pressure vessel. The sodium hydroxide (5) from the sodium hydroxide electrolyzer (4) and ferrosilicon (not shown), and are combined within the pressure vessel where a controlled amount of water is added which heats the mixture to about 200° F. (93° C.) and starts the reaction; sodium silicate, hydrogen and steam are produced. An example of the overall reaction of the process is:

2NaOH+Si+H₂O→2Na₂SiO₃+2H₂

Some advantages of using the wet process when compared with the dry process is that the wet process is often simpler, easier to operate, and with lower energy consumption, less investment, and higher product quality and lower cost. If the dry method is a two-step method, the wet method will be a one-step method. As water is required in the geopolymer cementitious mixture, the sodium silicate (6) is transmitted to the geopolymer cement mixer as water glass and may allow water to be added with the sodium silicate (6) reducing mixing time and simplifying the movement of sodium silicate with pumps and reducing heat requirements of evaporating water from the mixture unnecessarily for it then to be reintroduced at the geopolymer mixing stage (1). The hydrogen produced by the wet process (not shown) can be combined with the hydrogen (9) produced by the electrolyzer (4).

In one embodiment of the invention the combustion stage of the process receives hydrogen (9) from the sodium hydroxide electrolyzer (4) and/or additional sources of hydrogen such as that made by the sodium silicate (6) wet process or external sources of hydrogen (not shown) and combusts the product compound through a turbine, engine, fuel cell, burner or other method of producing power and heat from hydrogen (9). The power is used to supply some or all of the electrical demands of the geopolymer production facility for example, pumps, compressors, electric heater, lights, mixers or other need to operate the plant. The heat contained within the high temperature gases leaving through the gas turbine exhaust from the combustion stage (10) are used to support the inventions process demands such as the sodium silicate (6) step within the chemical plant. Any surplus heat and power can also be utilized to support other site services such as in one embodiment of the same invention the plant includes a fly ash drying/preheating (11) stage and geopolymer cementitious mixture curing (3). In another embodiment of the same invention the heat from the combustion stage (10) fly ash drying/preheating (11) stage and geopolymer cementitious mixture curing (3).

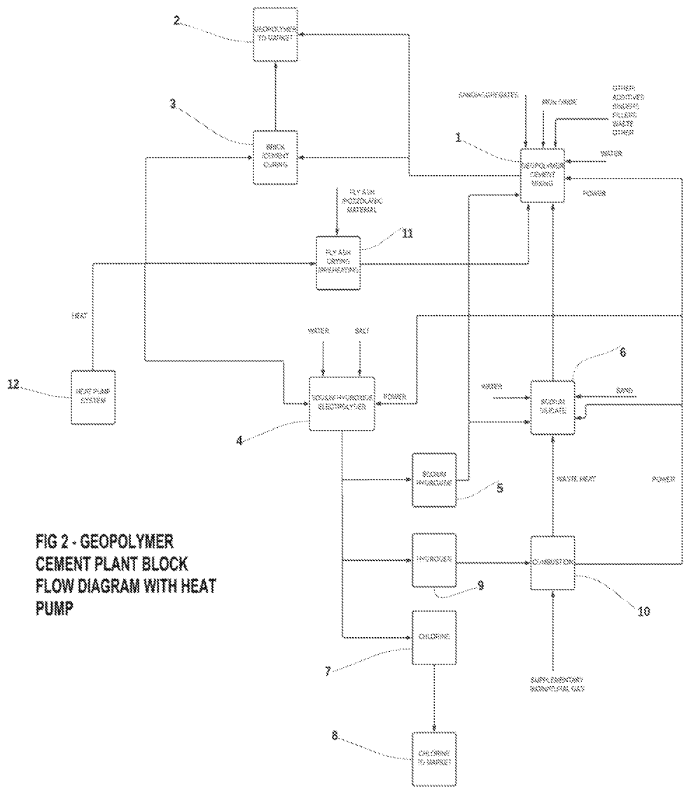

Referring to FIG. 2, in one embodiment of the same invention a Heat Pump (12) stage provides essential green energy for the production of the geopolymer cementitious mixture. One of the distinct advantages of using geopolymers is that the thermal demands of the production plant are much lower than a comparable Portland Cement production plant, and therefore less fuels need combusting to fulfill the heat demand making them more environmentally friendly. Generally and by way of example, heat pumps transfer heat from one place to another and are driven by the thermodynamic properties of the working fluids and the associated air or heat sources. Air source heat pumps move heat between the inside and outside of a building, the ground source heat pumps (known as geothermal heat pumps) transfer heat between inside a building and the ground outside.

Although the benefits of both systems are covered by this invention with more than one type of working fluid, the advantages of transcritical-CO₂ geothermal heat pumps will be discussed in more detail due to their innovative nature and high-temperature capability. The transcritical-CO₂ technology has advantages in terms of energy consumption and the equivalent carbon content as a natural fluid when compared to some other refrigerant working fluids. The thermal benefits transfer into comparatively reduced pipe and equipment size, therefore, reducing the amount of earthworks needed to excavate to provide the required ground coils to meet the required heat duty.

Although a conventional refrigeration cycle where both the high-pressure heat rejection and low pressure heat absorption processes occur in the subcritical region and are part of the scope of this invention. The transcritical-CO₂ cycle occupies both the supercritical heat rejection and the subcritical heat absorption processes. The CO₂ fluid with low temperature and low pressure is generally compressed by the compressor and transitions into the supercritical state with higher pressure and higher temperature push the fluid above the critical point. As the CO₂ flows through the gas-cooler, heat is transferred with the drying fluid for example air, water, steam or other medium used for low temperature heating operations such as geopolymer cementitious mixture curing (3), activation (not shown), fly ash drying/preheating (11) stage, water preheating (not shown), building heating (not shown), sodium hydroxide electrolyzer (4) warming, sodium silicate (6) heating or preheating, other feedstock (not shown) and non-feedstock (not shown) heating operations. The thermal range of the low temperature heating operations are dependent on the working fluid used but for exemplary purposes when using a CO₂ fluid working fluid will usually be between 60° C. and 120° C. After cooling through the gas cooler, the CO₂ and any other heating and cooling sections of the system the CO₂ is throttled through an expansion valve, pressure relief valve (not shown), ejector (not shown), pressure exchanger (not shown), and other means of reducing pressure becoming a two-phase fluid with low pressure and low temperature. After absorbing heat and evaporating in the evaporator, the CO₂ fluid flows back to the compressor and completes the whole cycle. By creating heat through the Joule-Thompson effect and favorable working fluid properties the majority of the heat needed for the geopolymer processing plant is provided through environmentally friendly means and electricity from the grid, and very low levels of CO₂ emissions are produced when compared to using traditional cement. Alternative heat pump arrangements may be used, and further advantages may be gained through using a combination of working fluids to achieve high temperatures in a more efficient way.

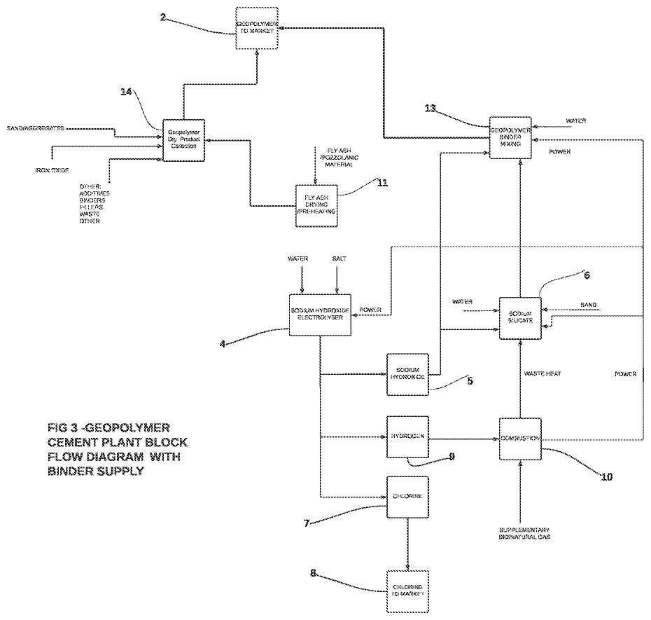

Referring to FIG. 3, in one embodiment of the same invention, the sodium hydroxide (5) solution is routed to both the geopolymer binder mixing (13) stage process and sodium silicate (6) stage process in the required proportions needed by each process. The sodium silicate (6) is produced using methods previously described in other embodiments of this invention. Once the sodium silicate (6) is processed into the desired concentration it is routed to the geopolymer binder mixing (13) stage. The sodium hydroxide (5) and sodium silicate (6) are mixed into a homogenous mixture in the geopolymer binder mixing (13) stage to produce a geopolymer binder. The geopolymer binder mixing (13) stage then routes the geopolymer binder direct to the customer as geopolymer to market (2) for use within a geopolymer product. The geopolymer dry product collection (14) stage can be located at the same geographical location or in a different geographical location to the geopolymer production plant described within this invention. The geopolymer dry product collection (14) stage collects all the substantially dry components that are combined to produce a geopolymer cementitious material including dry already dry fly ash, fly ash from the fly ash drying/preheating (11) stage, iron oxide, tailings, sand, aggregates, gravel waste products and other compounds. The geopolymer dry product collection (14) stage then routes these products either premixed or individually to the geopolymer to market (2) stage where they are combined with the geopolymer binder from the geopolymer binder mixing (13) to produce a final geopolymer cementitious material.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

What is claimed:

1. A method of producing a geopolymer cementitious material with at least one geopolymer cement mixing stage with at least sodium hydroxide producing stage to provide chemical feedstock.

2. The method of claim 1, wherein a geothermal heat pump is used for heat.

3. A method of producing a geopolymer cementitious material with at least one geopolymer cement mixing stage with at least sodium silicate producing stage to provide chemical feedstock.

4. The method of claim 3, wherein a geothermal heat pump is used for heat.

5. A method of producing a geopolymer binder material with at least one geopolymer cement binder mixing stage with at least with at least sodium hydroxide producing stage to provide chemical feedstock.

6. The method of claim 5, wherein a geothermal heat pump is used for heat.
